(19) United States
(12) Patent Application Publication
(10) Pub. No.: US 2015/0193002 A1
(43) Pub. Date: Jul. 9, 2015

(54) METHOD FOR EXECUTING SERVICE USING MOTION RECOGNITION AND DISPLAY APPARATUS EMPLOYING THE SAME

(71) Applicant: SAMSUNG ELECTRONICS CO., LTD., Suwon-si (KR)

(72) Inventor: Seok-min JUNG, Suwon-si (KR)

(73) Assignee: SAMSUNG ELECTRONICS CO., LTD., Suwon-si (KR)

(21) Appl. No.: 14/471,188

(22) Filed: Aug. 28, 2014

(30) Foreign Application Priority Data
Jan. 8, 2014 (KR) 10-2014-0002532

(51) Int. Cl. G06F 3/01; G06F 3/0484

(52) U.S. Cl. CPC G06F 3/017; G06F 3/04842

(57) ABSTRACT

A display apparatus is provided. The display apparatus includes a motion recognition device configured to recognize a user motion, a display device configured to display an image on a screen; an application execution device configured to execute at least one portion of a service, and a controller configured to control the display device to capture the displayed image and display at least one service item which is related to the captured image with the captured image on the screen in response to the user motion being recognized, and control the application execution device to execute the at least one portion of the service which corresponds to a selected service item selected by the user motion.

### CROSS-REFERENCE TO RELATED APPLICATION

This application claims priority from Korean Patent Application No. 10-2014-0002532, filed on Jan. 8, 2014, in the Korean Intellectual Property Office, the disclosure of which is incorporated herein by reference in its entirety.

### BACKGROUND

1. Field

Apparatuses and methods consistent with exemplary embodiments relate to a method for executing service using motion recognition and a display apparatus employing the same. In particular, exemplary embodiments relate to a method for executing service related to displayed content by recognizing user motion, and a display apparatus employing the same.

2. Description of the Related Art

Display apparatuses of the related art are apparatuses which display content transmitted from external apparatuses, or stored therein on a screen in an image form. Display apparatuses may include televisions (TVs), monitors, or the like.

Users want to watch broadcasting using the display apparatuses of the related art, and quickly use pieces of content displayed in the display apparatuses. However, for the users to use the pieces of content displayed in the display apparatuses, the users have to know information for the pieces of content and directly search the pieces of content.

However, the users may not recognize the information for the pieces of content. Further, since the users have to search on the Internet or the like to directly search the pieces of content, the user may not be able to simultaneously watch the content.

Further, to use the pieces of displayed content in the related art, the users have to use a button provided in the display apparatuses, a remote controller, or the like. Therefore, the users have to move toward the display apparatus to press the button or find the remote controller. However, the content to be used by the user may disappear on the screen when the user has to move or find the remote controller. Therefore, there is a need for a method to easily search for and quickly use the content displayed on the screen.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a method for easily and quickly executing a service related to content by executing the service related to displayed content through recognition of a user motion, and a display apparatus.

According to an aspect of an exemplary embodiment, there is provided a display apparatus. The display apparatus may include: a motion recognition device configured to recognize a user motion; a display device configured to display an image on a screen; an application execution device configured to execute at least one portion of a service; and a controller configured to control the display device to capture the displayed image and display at least one service item which is related to the captured image with the captured image on the screen in response to the user motion being recognized, and control the application execution device to execute the at least one portion of the service which corresponds to a selected service item selected by the user motion.

The controller may control the application execution device to select the service item located in a moving direction of the user motion and activate the selected service item in response to the user motion moving in a state in which the captured image and the at least one service item are displayed, and to execute the at least one portion of the service which corresponds to the activated service item in response to a preset user motion being recognized through the motion recognition device in a state in which the service item is activated.

The controller may be further configured to control the application execution device to immediately execute the at least one portion of the service which corresponds to the selected service item set which corresponds with a preset user motion in response to the preset user motion being recognized through the motion recognition device in a state in which the captured image and the at least one service item are displayed.

The controller may be further configured to transmit information for the captured image and the displayed image to the application execution device to execute the at least one portion of the service.

The controller may be further configured to control the application execution device to interrupt execution of the at least one portion of the service, and control the display device to remove a display screen of the executed at least one portion of the service, in response to the user motion being recognized again in a state in which the at least one portion of the service is executed after the user motion is first recognized before the image is captured.

The motion recognition device may include a camera module configured to capture a user who watches the image and generate a user image; a hand region detection module configured to detect a hand region of a user from the user image; and a recognition module configured to recognize a hand shape as the user motion in response to the detected hand region being matched with a pre-stored hand shape.

The controller may be further configured to control the display device to display the captured image to a size smaller than the image displayed on the screen in response to the user motion being recognized.

The controller may be further configured to control the display device to display the captured image in a semitransparent state on the screen in which the image is displayed, in response to the user motion being recognized.

The controller may be further configured to change a location of the captured image displayed on the screen in which the image is displayed according to a user setting.

The at least one service item may include at least one service item of a recording service item for recording the captured image, a social networking service (SNS) item for uploading the captured image, a shopping service item for shopping at least one good included in the captured image, and an after service (A/S) item related to an image quality of the captured image.

According to an aspect of an exemplary embodiment, there is provided a method for executing a service. The method may include: displaying an image on a screen; capturing the displayed image, and displaying at least one service item which is related to the captured image with the captured image on the screen, in response to a user motion being recognized; and selecting a service item according to the user motion and executing the service which corresponds to the selected service item.

The executing the service which corresponds to the selected service item may include selecting the service item which is located in a moving direction of the user motion and activating the selected service item, in response to the user motion moving in a state in which the captured image and the at least one service item are displayed; and executing the service which corresponds to the activated service item in response to a preset user motion being recognized in a state in which the service item is activated.

The executing the service which corresponds to the selected service item may include immediately executing the service which corresponds to the selected service item which corresponds with a preset user motion in response to the preset user motion being recognized in a state in which the captured image and the at least one service item are displayed.

The method may further include interrupting execution of the service and removing a display screen of the executed service in response to the user motion being recognized again in a state in which the service is executed after the user motion is first recognized before the image is captured.

The at least one service item may be at least one service item a recording service item for the captured image, a social networking service (SNS) item for uploading the captured image, a shopping service item for shopping at least one good included in the captured image, and an after service (A/S) item related to image quality of the captured image.

According to an aspect of an exemplary embodiment, there is provided a display apparatus. The display apparatus may include: a display device configured to display an image on a screen; a motion recognition device configured to recognize a user motion; and a controller configured to control the display device to capture the displayed image and display the captured image and at least one of a recording service item for the captured image; a social network service item for the captured image, and an after service item for the captured image on the screen in response to the motion recognition device recognizing a first user motion.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a configuration of a display apparatus according to an exemplary embodiment;

FIG. 2 is a block diagram illustrating a configuration of a motion recognition unit according to an exemplary embodiment;

FIG. 3 is view illustrating a user motion recognition method according to an exemplary embodiment;

FIGS. 4A to 4C are views illustrating a service execution method according to an exemplary embodiment;

FIGS. 5A and 5B are views illustrating a service execution method according to another exemplary embodiment;

FIG. 6 is a view illustrating a service termination method according to an exemplary embodiment;

FIGS. 7A to 7E are views illustrating user interface screens for setting a motion recognition function according to an exemplary embodiment; and

FIG. 8 is a flowchart illustrating a service execution method according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

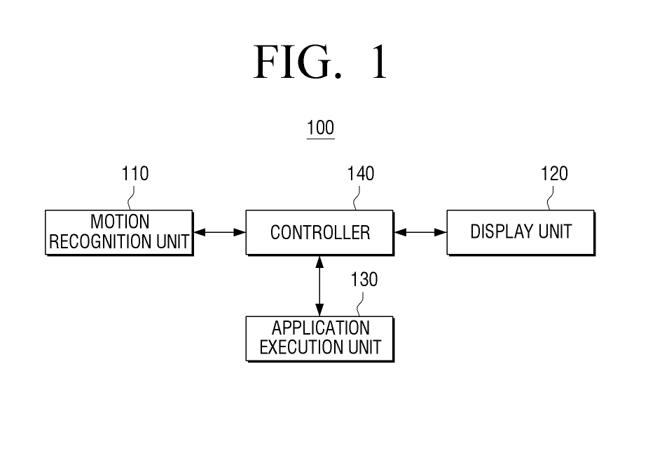

FIG. 1 is a block diagram illustrating a configuration of a display apparatus according to an exemplary embodiment. Referring to FIG. 1, a display apparatus 100 includes a motion recognition unit 110, a display unit 120, an application execution unit 130, and a controller 140. The display apparatus 100 may be a television (TV) or a smart TV. In addition, the display apparatus 100 may be a monitor of a desktop computer, a laptop computer, or a tablet personal computer (PC). Further, at least one of the motion recognition unit 110, the display unit 120, the application unit 130, and the controller 140 may include at least one of a hardware module, a circuit, and at least one processor for performing their respective functions.

The motion recognition unit 110 recognizes a user motion. The user motion is a motion for a hand of a user, and the user motion may be a shape of the hand or movement of the hand. The motion recognition unit 110 may detect the shape of the hand from a user image which captures the user.

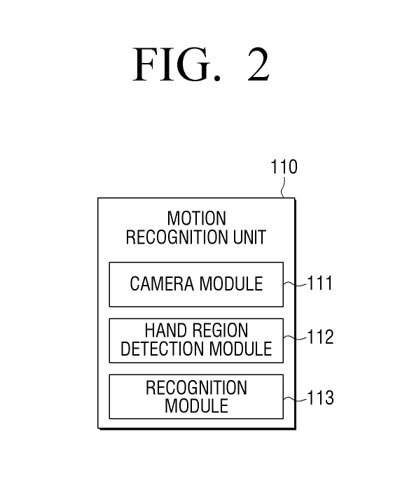

The configuration of the motion recognition unit 110 is illustrated in FIG. 2. Referring to FIG. 2, the motion recognition unit 110 may include a camera module 111, a hand region detection module 112, and a recognition module 113.

The camera module 111 captures the user who watches an image and generates a user image. The camera module 111 may be located outside the display apparatus 100, and the camera module 111 may be located toward a direction to which the user is located. Further, to detect an accurate hand shape, a plurality of camera modules 111 may be provided in different locations of the display apparatus 100.

The hand region detection module 112 detects a hand region of the user from the user image. In particular, the hand region detection module 112 detects at least one skin color region from the user image. The hand region detection module 112 extracts a contour of the at least one skin color region, detects a skin color region having a contour corresponding to the hand shape, and detects the hand region.

The recognition module 113 may recognize the matched hand shape as the user motion in response to the detected hand region being matched with at least one hand shape which is pre-stored. The pre-stored at least one hand shape may be a hand shape based on contour data for various hand shapes or hand images which capture various hand shapes. The contour data, the hand images, or the like may have been stored in an internal memory of the motion recognition unit 110 or a memory of the display apparatus 100.

The method of detecting the hand shape is not limited to the above-described methods. Therefore, other known methods may be used to detect the hand shapes. For example, in response to the hand region being detected by the hand region detection module 112, the recognition module 113 may recognize the hand shape in a manner to trace feature points (for example, hand end points) of the hand.

The display unit 120 displays an image on a screen. The displayed image may be an image for content transmitted to the display apparatus 100 from an external apparatus or an image for content stored in the display apparatus 100. The content may be a movie, TV/cable broadcasting, a game, an animation, a music video, or the like. However, the content is not limited thereto, and all other content which may be displayed in an image manner may be included.

The application execution unit 130 executes at least one piece of a service. The service may be provided from the display apparatus 100, and include at least one service selected from the group consisting of a recording service, a social network service (SNS), shopping service, and after service (A/S). The application program configured to execute the at least one piece of service may be stored in an internal memory of the application execution unit 110 or a memory of the display apparatus 100. Therefore, the application execution unit 130 may read a stored application program and execute the application.

The controller 140 controls an overall operation of the display apparatus 100. In particular, the controller 140 controls a service execution function included in the display apparatus 100. The service execution function may be a function to recognize the user motion and execute the service.

In response to the user motion being recognized through the motion recognition unit 110 in a state in which the image is displayed, the controller 140 controls the display unit 120 to capture the displayed image, and display at least one service item related to the captured image with the captured image on the screen. The controller 140 may display the captured image in various methods.

In particular, the controller 140 may display the captured image to a size smaller than the displayed image on the screen, or display the captured image on an entire screen. Alternatively, the controller 140 may display the captured image in a semitransparent state on the screen in which the image is displayed. As described above, the display method of the captured image may be changed according to user setting.

The controller 140 controls the application execution unit 130 to execute service corresponding to at least one service item selected by the user motion.

In one exemplary embodiment, the controller 140 may select the service item located in a moving direction of the user motion and activate the service item in response to the user motion moving in a state in which the captured image and the at least one service item are displayed. In response to a preset user motion being recognized through the motion recognition unit 110 in a state in which the service item is activated, the controller 140 may control the application execution unit 130 to execute the service corresponding to the activated service item. The preset user motion may be a hand shape set to execute the service corresponding to the activated service item.

For example, in response to the preset hand shape being a paper shape (e.g., an open hand with the fingers extending and touching) in a rock-paper-scissors arrangement and the paper shape being recognized in a state in which the at least one service item is activated, the controller 140 may control the application execution unit 130 to execute the service corresponding to the activated service item.

In another exemplary embodiment, in response to the preset user motion being recognized through the motion recognition unit 110 in a state in which the captured image and the at least one service item are displayed, the controller 140 may control the application execution unit 130 to select a service item corresponding to the preset user motion and immediately execute the selected service item. In the exemplary embodiment, the preset user motion may be a hand shape set to correspond to the at least one service item.

For example, in response to a scissor shape (e.g., two fingers extended and separated) in a rock-paper-scissors arrangement being set with respect to a recording service item and the scissor shape being recognized in a state in which the at least one service item is displayed, the controller 140 may control the application execution unit 130 to immediately execute the service corresponding to the recording service item.

The controller 140 transmits information for the captured image and the displayed image to the application execution unit 130 to execute the service item. The information for the displayed information may include a title of content, a kind of content, information for content provider, content brief information, or the like.

The user motion is recognized before the image is captured. Further, when the user motion is recognized again in a state in which the service is executed, the controller 140 may control the application execution unit 130 to interrupt execution of the service. At this time, the controller 140 may control the display unit 130 to remove an executed service screen from on the screen.

The display apparatus 100 illustrated in FIG. 1 may recognize the user motion such as the hand shape or hand movement and execute the service. Therefore, since the user may execute the service related to the image using the hand while watching the image, the user may easily fast execute the service without operation or finding of a remote controller.

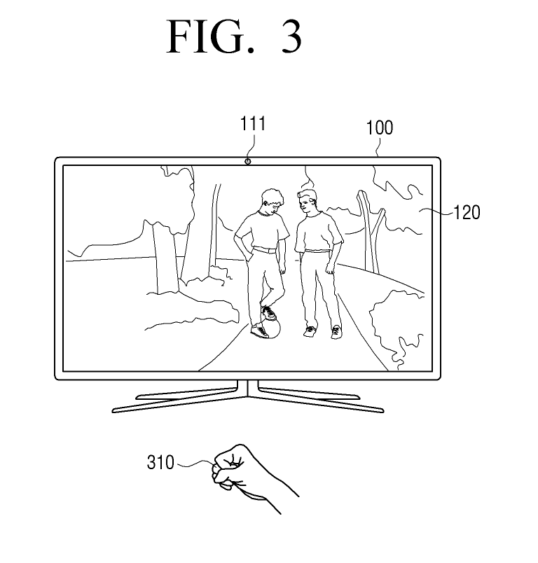

FIG. 3 is a view illustrating a user motion recognition method according to an exemplary embodiment. Referring to FIG. 3, the display apparatus 100 displays an image according to content through the display unit 120. The display apparatus 100 may capture the user using the camera module 111 while displaying the image, and detect a hand shape from a user image. The display apparatus 100 may recognize the detected hand shape or the hand shape (that is, hand movement) changed over time as the user motion.

In response to a preset user motion being recognized, the display apparatus 100 may display the at least one service item related to the captured image together with the captured image.

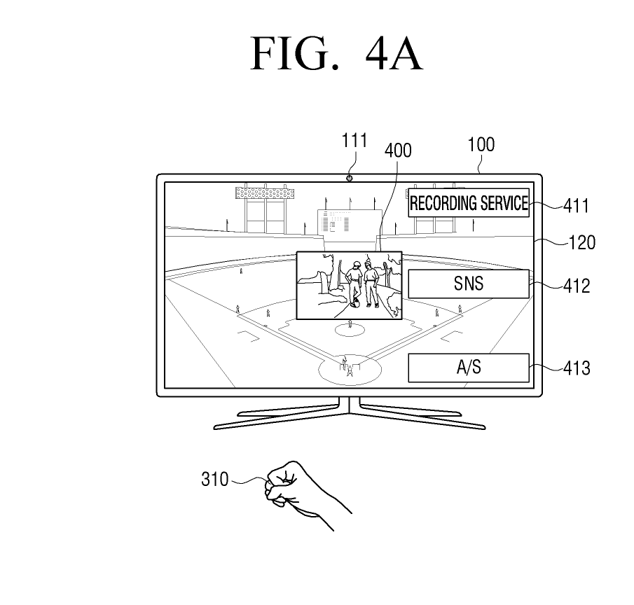

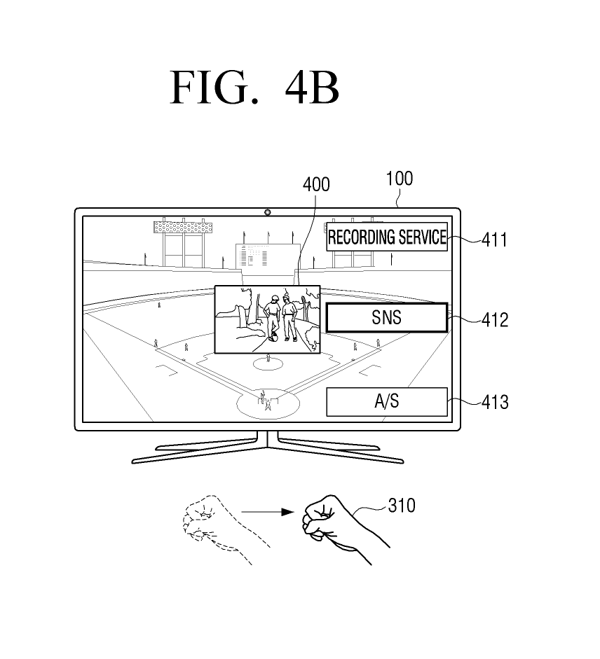

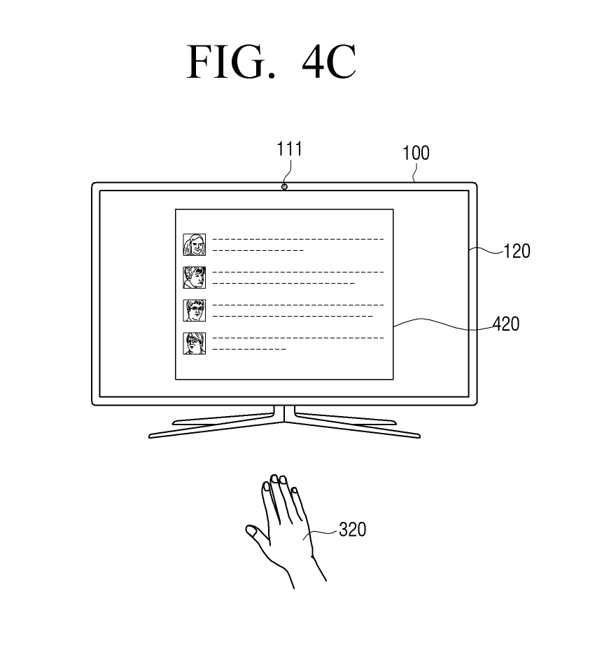

For example, in response to a rock shape (e.g., clenched first) in a rock-paper-scissors arrangement being set as the user motion in relation to a start operation and a termination operation of a service execution function and a rock shape 310 being recognized while the display apparatus 100 displays the image, the display apparatus 100 starts the service execution function. Therefore, the display apparatus 100 captures the displayed image, and displays at least one service item related to the captured image. A display screen according to the operation is illustrated in FIG. 4A.

FIGS. 4A to 4C are views illustrating a service execution method according to an exemplary embodiment.

In response to recognizing the rock shape 310 while displaying an image, the display apparatus 100 displays a captured image 400, a recording service item 411 for the captured image, an SNS item 412 for the captured image, and an A/S item 413 for the captured image on the screen as illustrated in FIG. 4A.

The recording service item 411 is configured to record an image related to the captured image. The SNS item 412 is configured to execute SNS for uploading the captured image or transmitting the capture image to any subject. Further, in response to the displayed image being abnormal, the A/S item 413 is configured to transmit the captured image to an A/S center and apply A/S.

When the captured image 400 and three service items 411, 412, and 413 are displayed on the screen, in response to the rock shape 310 moving to a horizontal direction as illustrated in FIG. 4B, the display apparatus 100 selects the SNS item 412 located in the horizontal direction of the captured image 400 and activates the SNS item 412.

To display that the SNS item 412 is activated, the display apparatus 100 may display a border of the SNS item 412 to be thick and bold, and may apply a flickering display effect to the SNS item 412.

In response to a paper shape 320 being recognized in a state in which the SNS item 412 is activated, as illustrated in FIG. 4C, the display apparatus 100 may execute SNS corresponding to the SNS item 412. In other words, the display apparatus 100 may display an SNS screen 420 to upload the captured image 400 onto the SNS screen 420 or transmit the captured image 400 to a specific subject through the SNS screen 420, under control of the user. At this time, SNS previously set by the user may be executed, and the SNS may be Twitter, Facebook, or the like.

The paper shape 320 may be a user motion previously set to execute a service corresponding to the activated service item. Therefore, in response to recognizing the paper shape 320 in a state in which the recording service item 411 is activated, the display apparatus 100 may execute a recording service corresponding to the recording service item 411.

The recording service records an image related to the captured image 400. The image related to the captured image 400 may be an image continuously displayed subsequent to the captured image 400.

Although not shown in drawings, in response to the recording service item 411 being activated, the display apparatus may display a user motion for executing the recording service corresponding to the recording service item 411 around the recording service item 411. For example, in response to the recording service item 411 being activated, an emoticon having a paper shape may be displayed on the left of the recording service item 411. Therefore, even when the user does not know the hand shape for service execution or forgets the hand shape for service execution, the user may know the hand shape through an emoticon having a paper shape displayed on the screen.

In response to image quality of the displayed image being issued, the user may activate the A/S item 413, and then change the hand shape to the paper shape 320. Therefore, the display apparatus 100 may execute A/S application service corresponding to the A/S item 413. In particular, the display apparatus 100 may access an Internet site which may apply A/S, and execute the A/S application service in an upload manner of the captured image 400 and user information (for example, an address, a phone number, a name, a product model name of the display apparatus 100, or the like).

Although not shown in the drawings, the display apparatus 100 may further display a shopping service item. In response to purchasing a product (e.g., article) included in the displayed image, the user may activate the shopping service item, and then change the hand shape to the paper shape 320. Therefore, the display apparatus 100 may execute the shopping service in a manner to detect at least one product (e.g., article) included in the captured image 400, discriminate a product name (e.g., logo or brand name) or the like shown in the product, search a shopping site which sells the corresponding product, and display the shopping site on the screen.

According to the service execution method illustrated in FIGS. 4A to 4C, the user may easily and quickly execute the service by capturing the image displayed in the display apparatus 100 using the hand shape or the hand movement. Further, since it is unnecessary for the user to directly access a web site and input related information to execute A/S service or shopping service, convenience of the user is improved.

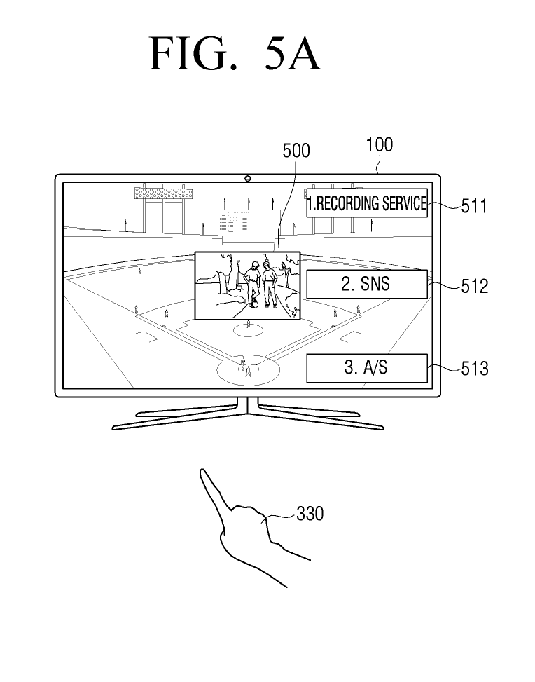

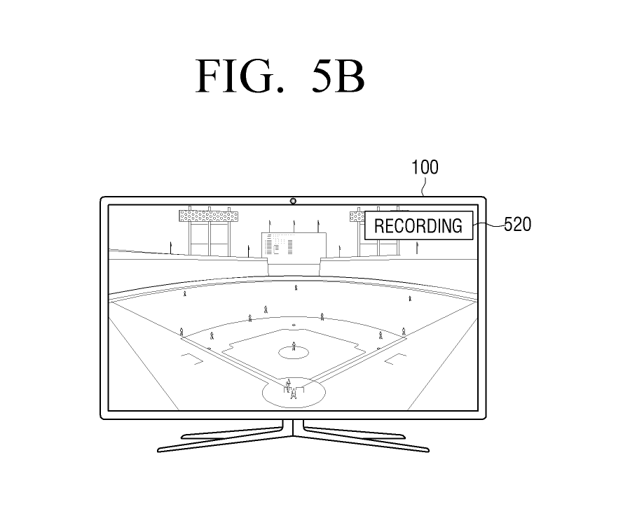

FIGS. 5A and 5B are views illustrating a service execution method according to another exemplary embodiment.

In response to recognizing the rock shape 310 while displaying an image as illustrated in FIG. 3, the display apparatus 100 displays a captured image 500, a recording service item 511 for the captured image 500, an SNS item 512 for the captured image 500, and an A/S item 513 for the captured image 500 on the screen as illustrated in FIG. 5A. Serial numbers such as 1, 2, and 3 may be displayed in the service items 511, 512, and 513. Alternatively, emoticons having hand shapes set to immediately execute service may be displayed in the service items 511, 512, and 513.

According to the exemplary embodiment, the display apparatus 100 sets the service items corresponding to specific hand shapes. For example, the recording service item 511 may be set to correspond to a hand shape in which one finger is spread out, the SNS item 512 may be set to correspond to a hand shape in which two fingers are spread out, and the A/S item 513 may be set to correspond to a hand shape in which three fingers are spread out. Therefore, in response to a specific hand shape being recognized, the display apparatus 100 may execute the service set to correspond thereto.

For example, in response to recognizing the hand shape in which one finger is spread out 330 as illustrated in FIG. 5A, the display apparatus 100 may immediately execute the recording service corresponding to the recording service item 511. Therefore, as illustrated in FIG. 5B, according to the execution of the recording service, the display apparatus 100 may record an image continuously displayed subsequent to the captured image 500. At this time, the display apparatus 100 may display a notification screen 520 which is configured to notify the user that the recording service is executing.

According to the service execution method illustrated in FIGS. 5A and 5B, the user may immediately execute the desired service and quickly execute the service only by taking a specific hand shape.

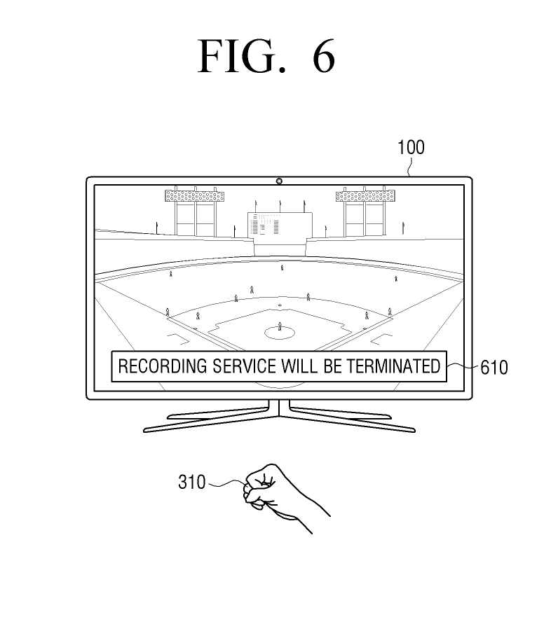

FIG. 6 is a view illustrating a service termination method according to an exemplary embodiment.

In a state in which any service is executed, the user may terminate execution of the service. In other words, the display apparatus may terminate a service execution function through recognition of the user motion.

In response to recognizing the rock shape 310 in a state in which the recording service is executed, the display apparatus 100 terminates execution of the recording service, and removes a display screen of the recording service (for example, the notification screen 520 illustrated in FIG. 5B).

Further, in response to termination of the service execution, the display apparatus 100 may display a notification screen 610 which is configured to notify the user that the execution of the service is terminated.

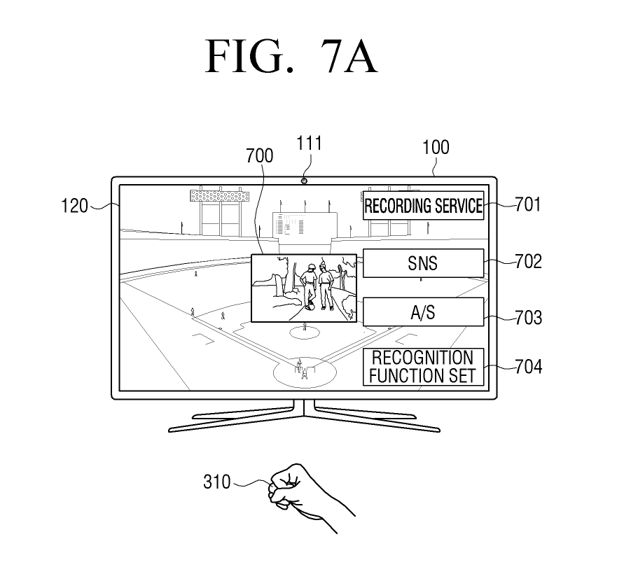

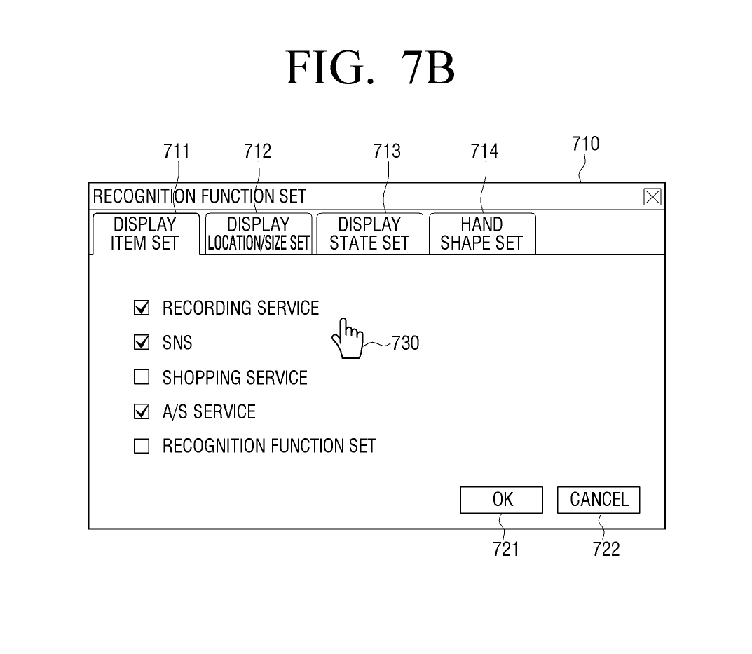

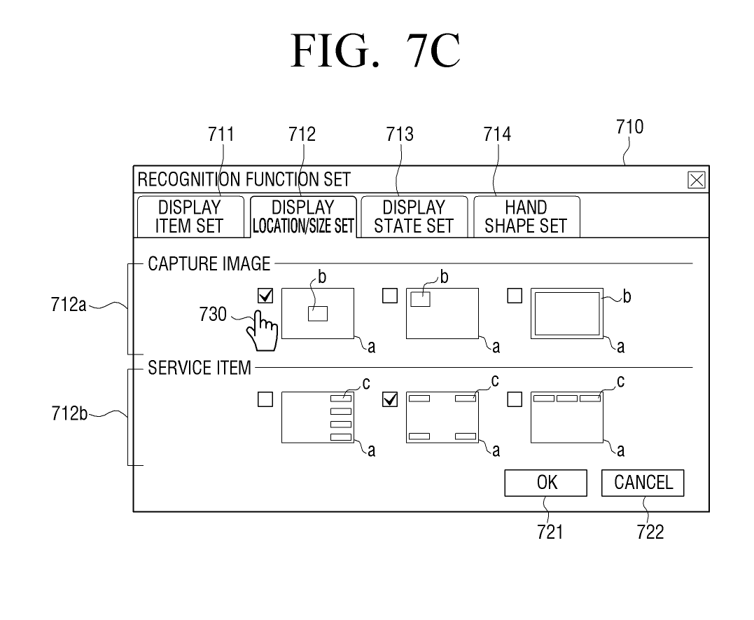

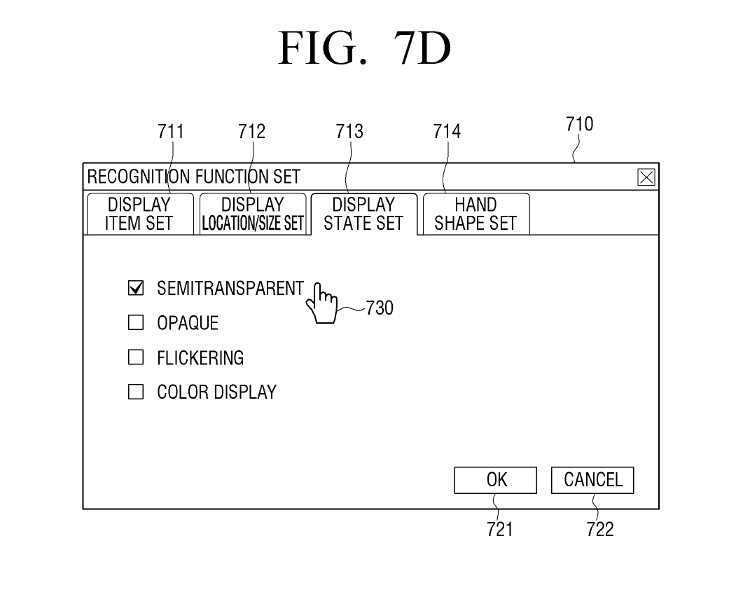

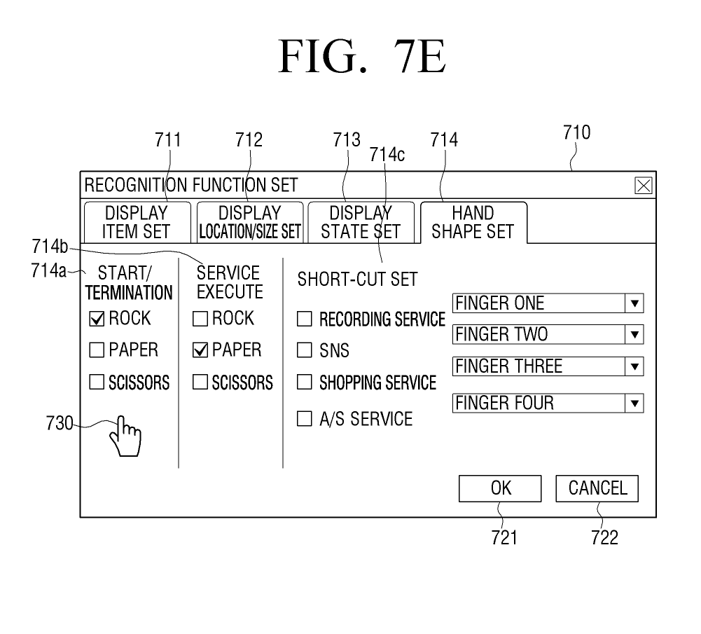

FIGS. 7A to 7E are user interface screens configured to set a motion recognition function according to an exemplary embodiment.

In response to recognizing the rock shape 310 in a state in which an image is displayed, the display apparatus 100 displays a captured image 700, and a recording service item 701, an SNS item 702, an A/S item 703, and a recognition function set item 704 for the captured image 700 on the screen. The recognition function set item 704 is to set functions related to the user motion.

In response to the recognition function set item 704 being selected according to the user motion, the display apparatus 100 may execute the recognition function set operation.

In response to execution of the recognition function set item 704, the display apparatus 100 display a recognition function set screen 710 on the screen as illustrated in FIG. 7B.

The recognition function set screen 710 includes a display item set tap 711, a display location/size set tap 712, a display state set tap 713, and a hand shape set tap 714. A hand-shaped pointer 730 may be displayed in the recognition function set screen 710, and the hand-shaped pointer 730 may move according to the user motion or control of a remote controller.

Referring to FIG. 7B, in response to the user motion being recognized while displaying an image, the display item set tap 711 is a region to set a service item to be displayed on the screen.

The user may move the hand-shaped pointer 730 to the display item set tap 711 in a manner to move the hand. In response to the hand-shaped pointer 730 being located (e.g., fixed) on the display item set tap 711 for several seconds (for example, 5 seconds) by the user, the display item set tap 711 may be displayed.

In response to an OK button 721 being pressed by the user after the user selects the recording service item, the SNS item, and the A/S service item on the display item set tap 711 using the hand-shaped pointer 730, the recording service item, the SNS item, and the A/S service item may be set to service items which are displayed on the screen.

In response to a cancel button 722 being pressed by the user, the recognition function set screen 710 may be removed on the screen.

In response to the hand-shaped pointer 730 being moved to the display location/size set tap 712, and then being located (e.g., fixed) on the display location/size set tap 712 for several seconds (for example, 5 seconds) by the user, the display location/size set tap 712 may be displayed as illustrated in FIG. 7C.

The display location/size set tap 712 is a region for setting a location or a size in which the captured image and the service item are to be displayed on the screen. The display location/size set tap 712 includes a region 712a (hereinafter, referred to as “capture image region”) for setting a display location and a size of the capture image, and a region 712b (hereinafter, referred to as “service item region”) for setting a display location for the service item.

The capture image region 712a may include various layouts which indicate a location and a size in which a captured image b is displayed on an entire screen a. Therefore, the user may select a desired layout in the capture image region 712a.

For example, in response to pressing the OK button 721 after the user selects a layout which indicates the captured image b in the center of the entire screen a and having a size smaller than the entire screen a, the display location and size of the captured image b may be set according to the selected layout.

Further, the service item region 712b may include various layouts which indicate a location and a size in which service items c are displayed in the entire screen a. Therefore, the user may select a desired layout in the service item region 712b.

For example, in response to pressing the OK button 721 after the user selects a layout in which the service items c are located in four corner regions of the entire region a, the display location of the service items c may be set according to the selected layout.

In response to the hand-shaped pointer 730 being moved to the display state set tap 713, and then being located on the display state set tap 713 for several seconds (for example, 5 seconds) by the user, the display state set tap 713 may be displayed as illustrated in FIG. 7D.

In response to the capture image or the service item being displayed on the screen, the display state set tap 713 is a region to set a display state in which the capture image or the service item is displayed. The display state set tap 713 may include display states such as “semitransparent”, “opaque”, “flickering”, “color display”, or the like.

For example, in response to pressing the OK button 721 after the user selects “semitransparent” in the display state set tap 713, the display state of the capture image or the service item may be set to “semitransparent”.

In response to the hand-shaped pointer 730 being moved to the hand shape set tap 714, and then being located on the hand shape set tap 714 for several seconds (for example, 5 seconds) by the user, the hand shape set tap 714 may be displayed as illustrated in FIG. 7E.

In response to implementing the service execution function according to the motion recognition, the hand shape set tap 714 may set the hand shapes for a start/termination operation, a service execution operation, and a service short-cut operation of the service execution function.

In response to pressing the OK button 721 after the user selects the rock in the start/termination region 714a, the rock shape may be set as the user motion for executing the start/termination operation of the service execution function. Therefore, in response to recognizing the rock shape while displaying the image, the display apparatus 100 may start the service execution function. In response to recognizing the rock shape again while executing the service, the display apparatus may terminate the service which is executing.

In response to pressing the OK button 721 after the user selects “paper” in the service execution region 714b, the paper shape may be set as the user motion for executing the service corresponding to the activated service item. Therefore, in response to recognizing the paper shape in a state in which any one service item is activated, the display apparatus 100 may execute the service corresponding to the activated service item.

In response to pressing the OK button 721 after the user selects a specific hand shape corresponding to each service item in the short-cut set region 714c, specific hand shapes may be individually set to a plurality of service items. Therefore, in response to recognizing any hand shape in a state in which the captured image and the at least one service item are displayed, the display apparatus 100 may immediately execute the service set to correspond to the hand shape.

Using the recognition function set screens 710 illustrated in FIGS. 7B to 7E, the user may set operations related to the motion recognition function according to the convenience and taste of the user,

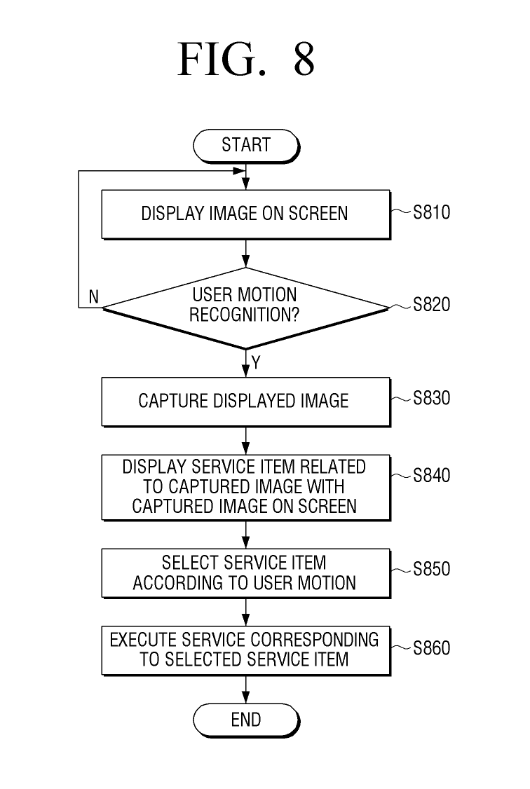

FIG. 8 is a flowchart illustrating a service execution method according to exemplary embodiment. The service execution method illustrated in FIG. 8 may be performed by the display apparatus 100 according to an exemplary embodiment.

Referring to FIG. 8, the display apparatus 100 displays an image on a screen (S810). In response to recognizing a user motion in a state in which the image is displayed (S820), the display apparatus 100 captures the displayed image (S830). The user motion may be a hand shape or hand movement. In other words, in response to the user clenching a first or moving in a scissors action, the display apparatus 100 may recognize the hand shape according to the hand movement as the user motion.

The display apparatus 100 may display at least one service item related to the captured image together with the captured image on the screen (S840), select any one service item according to the user motion (S850), and execute a service corresponding to the selected service item (S860).

According to the service execution method illustrated in FIG. 8, the user may display the at least one service item using the user motion, and execute the service item using a repeat of the same user motion. Therefore, the user may easily and quickly execute the desired service item.

The service execution method according to the exemplary embodiment may be implemented in a program including an executable algorithm which may be executed in a computer. The program may be stored in a non-transitory computer readable medium.

The non-transitory computer-recordable medium is not a medium configured to temporarily store data such as a register, a cache, or a memory but an apparatus-readable medium configured to semi-permanently store data. In particular, the programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided.

The foregoing exemplary embodiments and advantages are merely exemplary and are not to be construed as limiting. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a motion recognition device configured to recognize a user motion;
a display device configured to display an image on a screen;
an application execution device configured to execute at least one portion of a service; and
a controller configured to control the display device to capture the displayed image and display at least one service item which is related to the captured image with the captured image on the screen in response to the user motion being recognized, and control the application execution device to execute the at least one portion of the service which corresponds to a selected service item selected by the user motion.

2. The display apparatus as claimed in claim 1, wherein the controller is further configured to control the application execution device to select the service item located in a moving direction of the user motion and activate the selected service item in response to the user motion moving in a state in which the captured image and the at least one service item are displayed, and to execute the at least one portion of the service which corresponds to the activated service item in response to a preset user motion being recognized through the motion recognition device in a state in which the service item is activated.

3. The display apparatus as claimed in claim 1, wherein the controller is further configured to control the application execution device to immediately execute the at least one portion of the service which corresponds to the selected service item which corresponds with a preset user motion in response to the preset user motion being recognized through the motion recognition device in a state in which the captured image and the at least one service item are displayed.

4. The display apparatus as claimed in claim 1, wherein the controller is further configured to transmit information for the captured image and the displayed image to the application execution device to execute the at least one portion of the service.

5. The display apparatus as claimed in claim 1, wherein the controller is further configured to control the application execution device to interrupt execution of the at least one portion of the service, and control the display device to remove a display screen of the executed at least one portion of the service, in response to the user motion being recognized again in a state in which the at least one portion of the service is executed after the user motion is first recognized before the image is captured.

6. The display apparatus as claimed in claim 1, wherein the motion recognition device includes:
a camera module configured to capture a user who watches the image and generate a user image;
a hand region detection module configured to detect a hand region of the user from the user image; and
a recognition module configured to recognize a hand shape as the user motion in response to the detected hand region being matched with a pre-stored hand shape.

7. The display apparatus as claimed in claim 1, wherein the controller is further configured to control the display device to display the captured image at a size smaller than the image displayed on the screen in response to the user motion being recognized.

8. The display apparatus as claimed in claim 1, wherein the controller is further configured to control the display device to display the captured image in a semitransparent state on the screen in which the image is displayed, in response to the user motion being recognized.

9. The display apparatus as claimed in claim 1, wherein the controller is further configured to change a location of the captured image displayed on the screen in which the image is displayed, according to a user setting.

10. The display apparatus as claimed in claim 1, wherein the at least one service item is at least one service item of a recording service item for recording the captured image, a social networking service (SNS) item for uploading the captured image, a shopping service item for shopping at least one good included in the captured image, and an after service (A/S) item related to an image quality of the captured image.

11. A method for executing a service, the method comprising:
displaying an image on a screen;
capturing the displayed image and displaying at least one service item which is related to the captured image with the captured image on the screen, in response to a user motion being recognized; and
selecting a service item according to the user motion and executing the service which corresponds to the selected service item.

12. The method as claimed in claim 11, wherein the executing the service which corresponds to the selected service item includes:
selecting the service item which is located in a moving direction of the user motion, and activating the selected service item, in response to the user motion moving in a state in which the captured image and the at least one service item are displayed; and
executing the service which corresponds to the activated service item in response to a preset user motion being recognized in a state in which the service item is activated.

13. The method as claimed in claim 11, wherein the executing the service which corresponds to the selected service item includes immediately executing the service which corresponds to the selected service item which corresponds with a preset user motion in response to the preset user motion being recognized in a state in which the captured image and the at least one service item are displayed.

14. The method as claimed in claim 11, further comprising:
interrupting execution of the service, and removing a display screen of the executed service, in response to the user motion being recognized again in a state in which the service is executed after the user motion is first recognized before the image is captured.

15. The method as claimed in claim 11, wherein the at least one service item is at least one service item of a recording service item for recording the captured image, a social networking service (SNS) item for uploading the captured image, a shopping service item for shopping at least one good included in the captured image, and an after service (A/S) item related to image quality of the captured image.
